(19) United States
(12) Patent Application Publication
(10) Pub. No.: US 2026/0366810 A1
(43) Pub. Date: Nov. 19, 2026

(54) MULTI-CHANNEL POWER CONTROL APPARATUS, AND BATTERY ELECTRODE DRYING SYSTEM HAVING THE SAME

(71) Applicant: NARAENANOTECH CORPORATION, Yongin-si (KR)

(72) Inventors: Min Ho KIM, Seoul (KR); Kyoung Seung OH, Yongin-si (KR)

(21) Appl. No.: 19/726,760

(22) Filed: Jun. 30, 2026

Related U.S. Application Data
(63) Continuation of application No. PCT/KR2026/001672, filed on Jan. 28, 2026.

(30) Foreign Application Priority Data
Feb. 19, 2025 (KR) 10-2025-0021640
Apr. 24, 2025 (KR) 10-2025-0053765

(51) Int. Cl. F26B 3/30; H01M 4/04; H05B 41/36

(52) U.S. Cl. CPC F26B 3/30; H01M 4/0471; H05B 41/36

(57) ABSTRACT

A multi-channel power control apparatus according to an embodiment of the disclosure may include: a light source having a plurality of channel lamp units; a plurality of channel discharge parts performing discharging to each of the plurality of channel lamp units, wherein each of the plurality of channel discharge parts has a power supply and wherein each of the plurality of channel discharge parts corresponds to each of the plurality of channel lamp units; and a controller configured to control the plurality of channel discharge parts in a manner that the plurality of channel discharge parts discharges in sequence to a corresponding channel lamp unit among the plurality of channel lamp units.

### CROSS-REFERENCE TO RELATED APPLICATIONS

This is a bypass continuation of International PCT Application No. PCT/KR2026/001672, filed on Jan. 28, 2026, which claims priority to Republic of Korea Patent Application No. 10-2025-0021640, filed on Feb. 19, 2025, and Republic of Korea Patent Application No. 10-2025-0053765, filed on Apr. 24, 2025, which are incorporated by reference herein in their entirety.

### TECHNICAL FIELD

The disclosure relates to a multi-channel power control apparatus and a battery electrode drying system equipped with the same. More particularly, the disclosure relates to a multi-channel power control apparatus, which can be utilized in various fields using light sources such as xenon (Xe) flash lamps such as battery electrode drying, medical equipment, and precision optical equipment, and which has a gradual and stable output, allows for efficient power management by dispersing energy, prevents overheating by dispersing heat, improves durability by discharging each channel independently, has a stable output without discharge interference, and has a long lifespan, and a battery electrode drying system equipped with the same.

### BACKGROUND ART

Recently, light sources such as xenon flash lamps are being utilized in various fields, including battery electrode drying, medical equipment, and precision optical equipment. Such a light source irradiates flash light through the discharge of a power control apparatus such as a pulse power supply.

FIG. 9 is a graph showing the relationship between time and output of a discharge section of a power control apparatus according to the related art, and FIG. 10 is a photograph of a battery electrode dried by a battery electrode drying system equipped with a power control apparatus according to the related art.

With reference to FIG. 9, all channel discharge parts of the power control apparatus according to the related art discharge simultaneously. Hence, high energy is consumed because high light energy is generated simultaneously, and there is a risk of overheating due to heat concentration. In addition, there are problems such as the lamp's lifespan being shortened due to excessive discharge, unstable output resulting from discharge interference, and the equipment's lifespan being short. As can be seen from FIG. 10, the battery electrode dried by a battery electrode drying system equipped with a power control apparatus according to the related art has a problem in that the drying state of the electrode slurry is poor.

A related art regarding a modular pulse power supply is disclosed in patent document 1 (Korean Patent Registration Gazette No. 10-2410532). The modular pulse power supply according to patent document 1 allows for easy increase or decrease in output through the addition and removal of a pulse module. However, assuming that the modular pulse power supply according to patent document 1 discharges in sequence across multiple channels, discharge interference may occur between channels, causing the output to fluctuate. Additionally, a time delay problem may occur where discharge does not occur at precise intervals for individual channels. So, it cannot be utilized in fields where precise discharge control is performed, such as battery electrode drying systems.

A related art regarding a battery electrode sheet drying apparatus and a battery electrode sheet drying method is disclosed in patent document 2 (Korean Patent Registration Gazette No. 10-2388446). In the battery electrode sheet drying apparatus according to patent document 2, each set dries the battery electrode by using an infrared lamp unit equipped with a plurality of channel lamps. However, since all channel discharge parts discharging to the multiple channel lamps in patent document 2 discharge simultaneously, high light energy is generated simultaneously, resulting in high energy consumption and a risk of overheating due to the concentration of thermal energy. In addition, excessive discharge may shorten the lamp's life, and discharge interference may occur between multiple channels, resulting in unstable output and a short equipment lifespan.

### SUMMARY

An object of the disclosure is to provide a multi-channel power control apparatus that is capable of producing gradual and stable output, performing efficient power management by dispersing energy, and preventing overheating through heat dissipation, and a battery electrode drying system equipped with the same.

Another object of the disclosure is to provide a multi-channel power control apparatus that improves durability by discharging each channel independently, has a stable output without discharge interference, and has a long lifespan, and a battery sheet drying system equipped with the same.

Another object of the disclosure is to provide a multi-channel power control apparatus that can be applied to a battery electrode drying system by maintaining an accurate discharge interval, improves equipment productivity by allowing only the relevant module to be quickly replaced in the event of a failure, and reduces maintenance costs, and a battery electrode drying system equipped with the same.

To achieve the above objects, a multi-channel power control apparatus according to a first feature of an embodiment of the disclosure may include: a light source having a plurality of channel lamp units; a plurality of channel discharge parts performing discharging to each of the plurality of channel lamp units, wherein each of the plurality of channel discharge parts has a power supply and wherein each of the plurality of channel discharge parts corresponds to each of the plurality of channel lamp units; and a controller configured to control the plurality of channel discharge parts so that the plurality of channel discharge parts discharges in sequence to a corresponding channel lamp unit among the plurality of channel lamp units.

A multi-channel power control apparatus according to a second feature of an embodiment of the disclosure may include: a light source having a plurality of channel lamp units; a plurality of channel discharge parts performing discharging to each of the plurality of channel lamp units, wherein each of the plurality of channel discharge parts corresponds to each of the plurality of channel lamp units; a power supply configured to supply power to the plurality of channel discharge parts; and a controller configured to control the plurality of channel discharge parts so that the plurality of channel discharge parts discharges in sequence to a corresponding channel lamp unit among the plurality of channel lamp units.

A multi-channel power control apparatus according to a third feature of an embodiment of the disclosure may include: a light source having a plurality of channel lamp units; a plurality of channel discharge parts performing discharging to each of the plurality of channel lamp units, wherein each of the plurality of channel discharge parts corresponds to each of the plurality of channel lamp units; a charge bank configured to discharge to the plurality of channel discharge parts; a power supply configured to supply power to the charge bank so that the charge bank is charged; and a controller configured to control the charge bank so that the plurality of channel discharge parts discharges in sequence to a corresponding channel lamp unit among the plurality of channel lamp units.

A battery electrode drying system according to a fourth feature of an embodiment of the disclosure may include: a multi-channel power control apparatus; and a drying part that dries a battery electrode by utilizing flash light irradiated from the light source of the multi-channel power control apparatus, wherein the multi-channel power control apparatus may include: the light source having a plurality of channel lamp units; a plurality of channel discharge parts performing discharging to each of the plurality of channel lamp units, wherein each of the plurality of channel discharge parts has a power supply and wherein each of the plurality of channel discharge parts corresponds to each of the plurality of channel lamp units; and a controller configured to control the plurality of channel discharge parts so that the plurality of channel discharge parts discharges in sequence to a corresponding channel lamp unit among the plurality of channel lamp units.

A battery electrode drying system according to a fifth feature of an embodiment of the disclosure may include: a multi-channel power control apparatus; and a drying part that dries a battery electrode by utilizing flash light irradiated from the light source of the multi-channel power control apparatus, wherein the multi-channel power control apparatus may include: the light source having a plurality of channel lamp units; a plurality of channel discharge parts performing discharging to each of the plurality of channel lamp units, wherein each of the plurality of channel discharge parts corresponds to each of the plurality of channel lamp units; a power supply configured to supply power to the plurality of channel discharge parts; and a controller configured to control the plurality of channel discharge parts so that the plurality of channel discharge parts discharges in sequence to a corresponding channel lamp unit among the plurality of channel lamp units.

A battery electrode drying system according to a sixth feature of an embodiment of the disclosure may include: a multi-channel power control apparatus; and a drying part that dries a battery electrode by utilizing flash light irradiated from the light source of the multi-channel power control apparatus, wherein the multi-channel power control apparatus may include: the light source having a plurality of channel lamp units; a plurality of channel discharge parts performing discharging to each of the plurality of channel lamp units, wherein each of the plurality of channel discharge parts corresponds to each of the plurality of channel lamp units; a charge bank configured to discharge to the plurality of channel discharge parts; a power supply configured to supply power to the charge bank so that the charge bank is charged; and a controller configured to control the charge bank so that the plurality of channel discharge parts discharges in sequence to a corresponding channel lamp unit among the plurality of channel lamp units.

The following effects are achieved by utilizing the multi-channel power control apparatus and the battery electrode drying system equipped with the same of the disclosure.

1. It is possible to produce a gradual and stable output, perform efficient power management by dispersing energy, and prevent overheating through heat dissipation.

2. It is possible to improve durability by allowing each channel to discharge independently, produce stable output without discharge interference, and have a long lifespan.

3. It is possible to apply this to a battery electrode drying system by maintaining an accurate discharge interval, and improve equipment productivity and reduce maintenance costs by allowing only the relevant module to be quickly replaced in the event of a failure.

### BRIEF DESCRIPTION OF DRAWINGS

Hereinafter, preferred embodiments of a multi-channel power control apparatus according to the disclosure and a battery electrode drying system equipped with the same will be described in detail with reference to the accompanying drawings.

FIG. 1 is a block diagram of a multi-channel power control apparatus according to an embodiment of the disclosure.

FIG. 2 is a bottom view of a light source in a multi-channel power control apparatus according to an embodiment of the disclosure.

FIG. 3 is a graph showing the relationship between time and output of multiple channel discharge parts in a multi-channel power control apparatus according to an embodiment of the disclosure.

FIG. 4 is a graph showing the relationship between time and output for all channels and each channel in a multi-channel power control apparatus according to an embodiment of the disclosure.

FIG. 5 is a block diagram of a multi-channel power control apparatus according to a first variation for an embodiment of the disclosure.

FIG. 6 is a block diagram of a multi-channel power control apparatus according to a second variation for an embodiment of the disclosure.

FIG. 7 is a schematic cross-sectional view of a battery electrode drying system equipped with a multi-channel power control apparatus according to an embodiment of the disclosure.

FIG. 8 is a photograph of a battery electrode dried by a battery electrode drying system equipped with a multi-channel power control apparatus according to an embodiment of the disclosure.

FIG. 9 is a graph showing the relationship between time and output of a discharge part in a power control apparatus according to the related art.

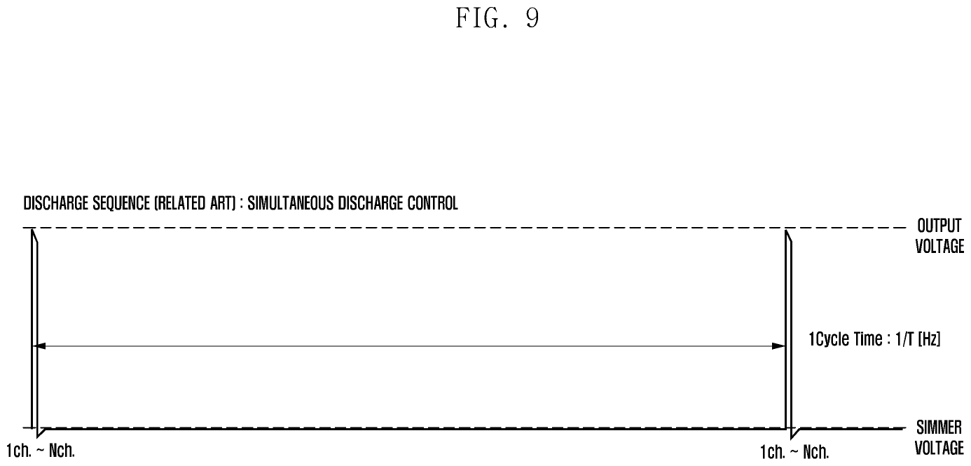

FIG. 10 is a photograph of a battery electrode dried by a battery electrode drying system equipped with a power control apparatus according to the related art.

### DETAILED DESCRIPTION

Hereinafter, preferred embodiments of a multi-channel power control apparatus according to the disclosure and a battery electrode drying system equipped with the same will be described in detail with reference to the accompanying drawings.

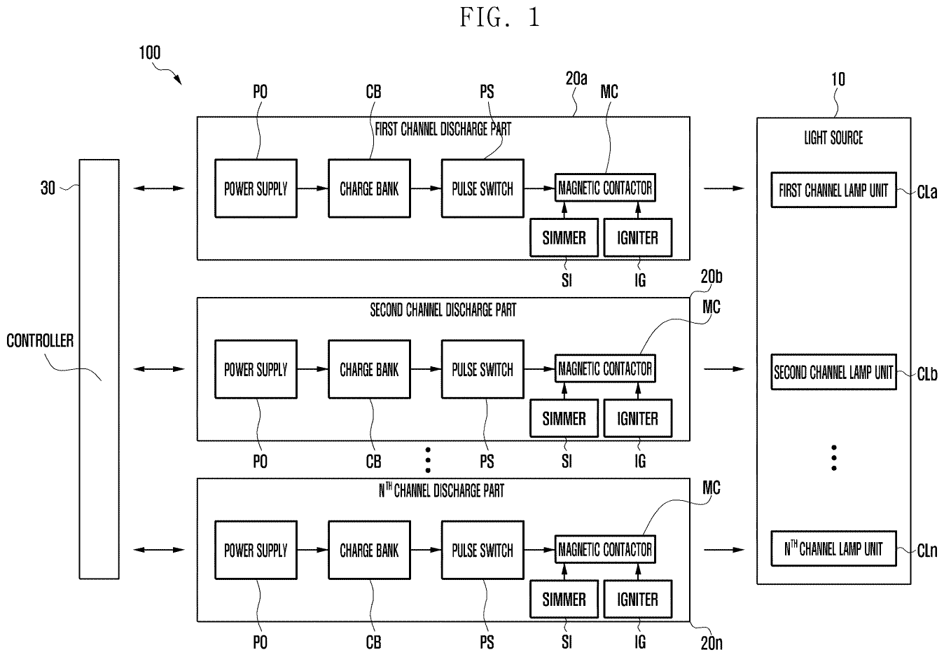

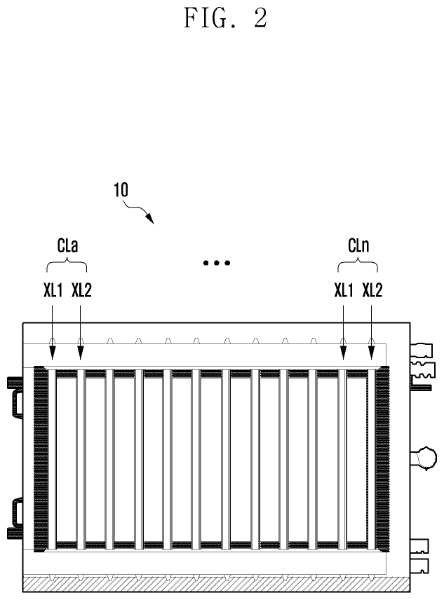

FIG. 1 is a block diagram of a multi-channel power control apparatus according to an embodiment of the disclosure, and FIG. 2 is a bottom view of a light source in a multi-channel power control apparatus according to an embodiment of the disclosure.

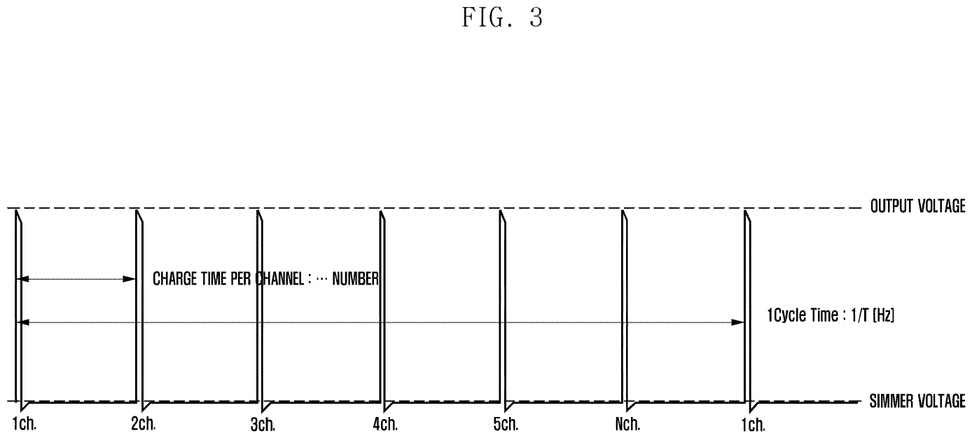

FIG. 3 is a graph showing the relationship between time and output of multiple channel discharge parts in a multi-channel power control apparatus according to an embodiment of the disclosure. In relation to FIG. 3, the horizontal axis represents time, and the vertical axis represents voltage.

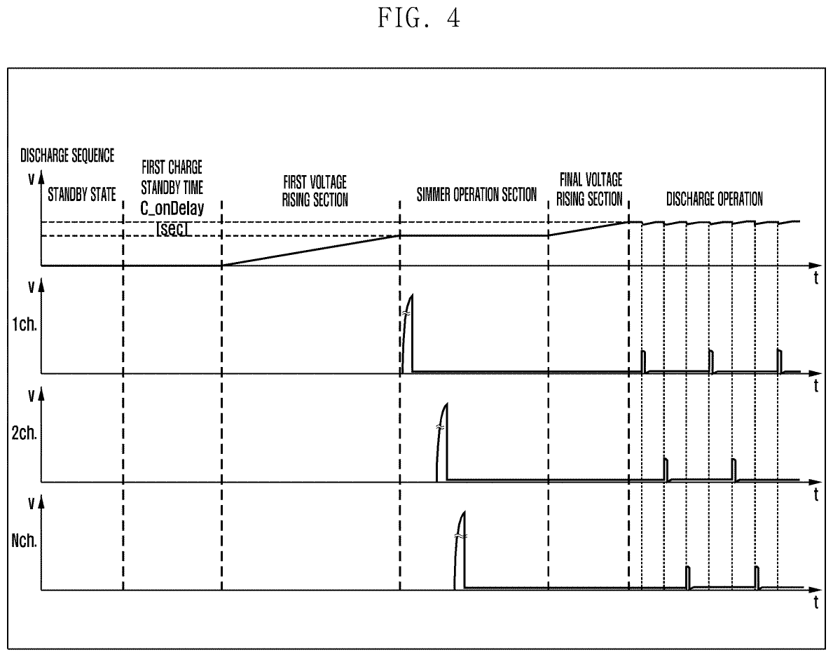

FIG. 4 is a graph showing the relationship between time and output for all channels and each channel in a multi-channel power control apparatus according to an embodiment of the disclosure.

In relation to FIG. 4, the horizontal axis of each graph represents time (t), and the vertical axis represents voltage (v). Additionally, the first graph, which is the top graph, represents the relationship between time and output for all channels of the multi-channel power control apparatus 100, the second graph represents the relationship between time and output for a first channel 1ch of the multi-channel power control apparatus 100, the third graph represents the relationship between time and output for a second channel 2ch of the multi-channel power control apparatus 100, and the fourth graph represents the relationship between time and output for a N^{th} channel Nch of the multi-channel power control apparatus 100.

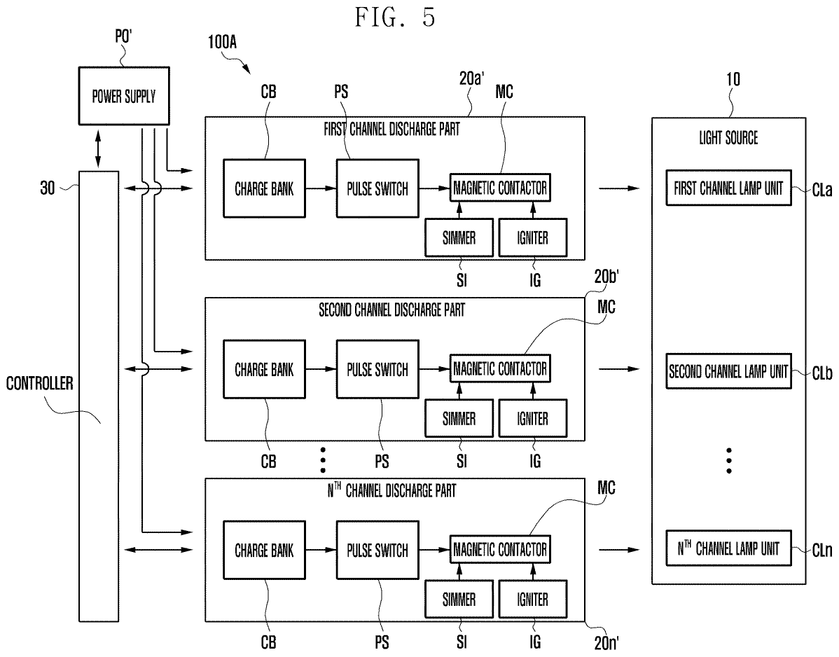

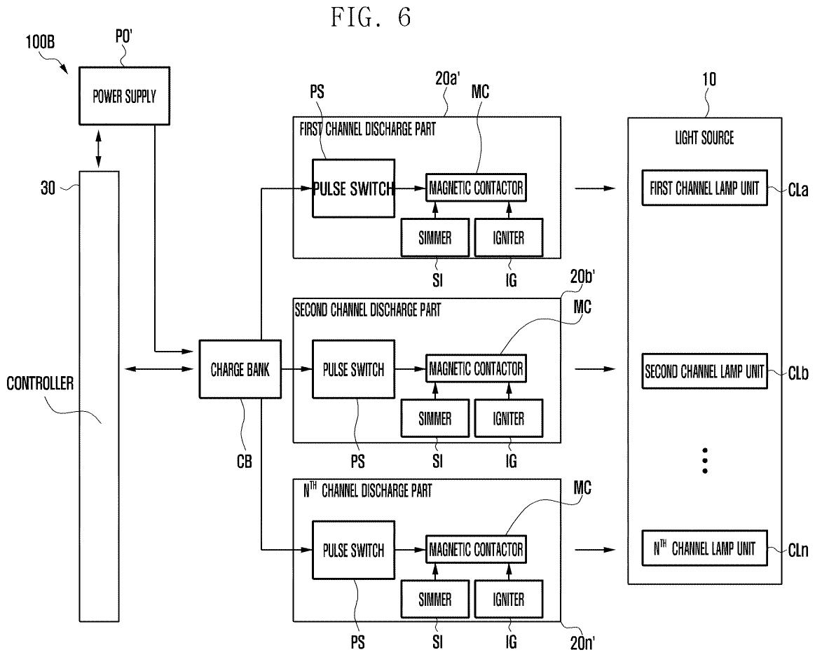

FIG. 5 is a block diagram of a multi-channel power control apparatus according to a first variation for an embodiment of the disclosure, and FIG. 6 is a block diagram of a multi-channel power control apparatus according to a second variation for an embodiment of the disclosure.

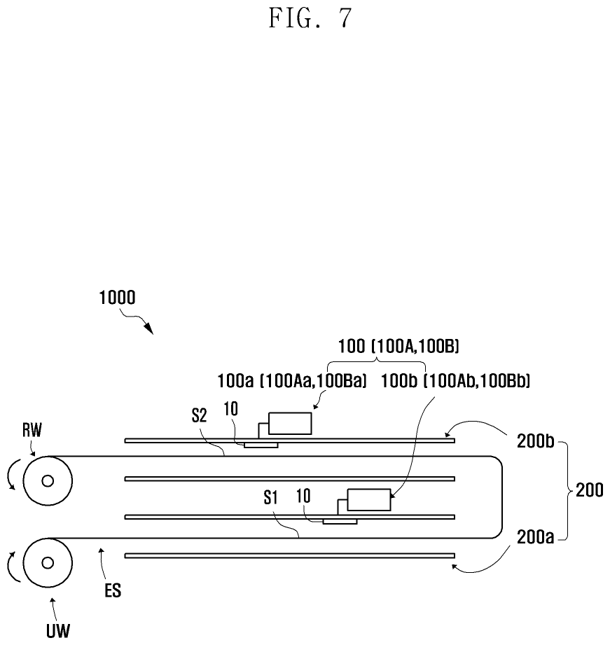

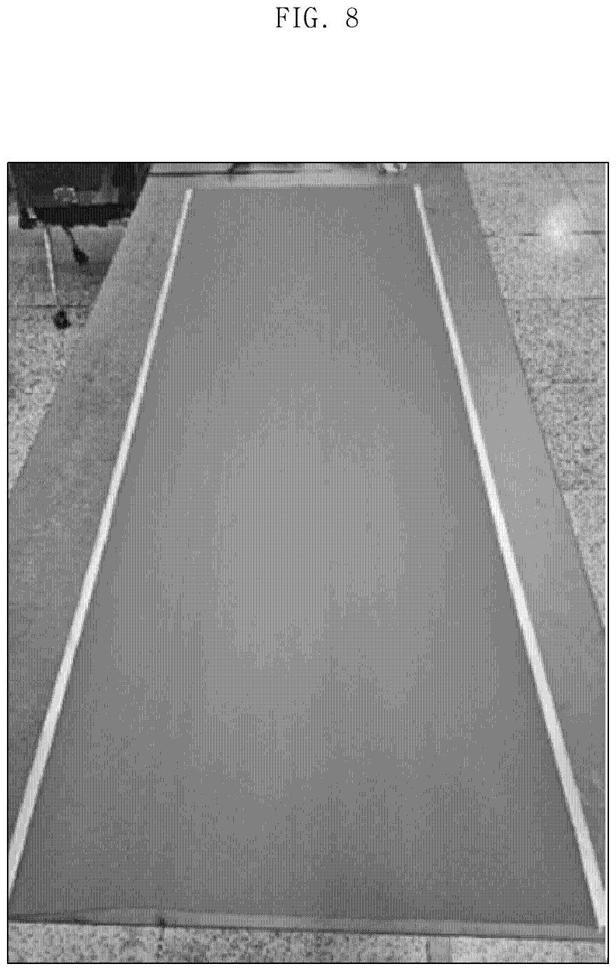

FIG. 7 is a schematic cross-sectional view of a battery electrode drying system equipped with a multi-channel power control apparatus according to an embodiment of the disclosure, and FIG. 8 is a photograph of a battery electrode dried by a battery electrode drying system equipped with a multi-channel power control apparatus according to an embodiment of the disclosure.

With reference to FIGS. 1 to 4, a multi-channel power control apparatus 100 according to an embodiment of the disclosure is described as follows.

The multi-channel power control apparatus 100 includes a light source 10, a plurality of channel discharge parts 20a to 20n, and a controller 30.

The light source 10 includes a plurality of channel lamp units CLa to CLn. With reference to FIG. 2, the plurality of channel ramp units CLa to CLn may each include one or more broadband ramps XL1 and XL2.

The light source 10 may be a broadband light source that irradiates light having multiple wavelengths of a broadband wavelength band. This broadband wavelength band may have a range from the ultraviolet wavelength band to the near-infrared wavelength band. For example, the range of the broadband wavelength band may be from 300 nm to 1200 nm.

A broadband light source may include at least one inert gas selected from Xe, Kr, Ar, Ne, and He. For example, a xenon lamp containing Xe gas may be used as a broadband light source.

The plurality of channel discharge parts 20a to 20n are components that perform discharging to each of the plurality of channel lamp units CLa to CLn. Each of the plurality of channel discharge parts 20a to 20n corresponds to each of the plurality of channel lamp units CLa to CLn. For example, assuming that there are N channels, the first channel discharge part 20a may correspond to the first channel lamp unit CLa, the second channel discharge part 20b may correspond to the second channel lamp unit CLb, the i^{th} channel discharge part (i is a natural number less than or equal to N) (not shown) may correspond to the i^{th} channel lamp unit (not shown), and the N^{th} channel discharge part 20n may correspond to the N^{th} channel lamp unit CLn.

Each of the plurality of channel discharge parts 20a to 20n includes a power supply PO. Additionally, the plurality of channel discharge parts 20a to 20n may each further include an igniter IG, a simmer SI, and a pulse switch PS. Additionally, the plurality of channel discharge parts 20a to 20n may each further include a magnetic contactor MC. In addition, the plurality of channel discharge parts 20a to 20n may each further include a charge bank CB.

The power supply PO is a component that supplies power to enable the corresponding one of the channel discharge parts 20a to 20n to perform discharging. The power supply PO may supply power to the charge bank CB. In this specification, the power supply PO may also be referred to as a “charging power supply” or a “capacitor charger”.

The igniter IG may apply an ignition voltage to the corresponding one of the channel lamp units CLa to CLn.

The simmer SI may output a simmer voltage.

The pulse switch PS may discharge a pulse having a peak voltage higher than the simmer voltage. With reference to FIG. 3, “the peak voltage of the pulse discharged by the pulse switch PS” may also be referred to as “the output voltage of the pulse switch PS”. In this specification, the pulse switch PS may also be referred to as a “lamp discharge part”.

The magnetic contactor MC may selectively apply one of ignition voltage and a combination of simmer voltage and pulse to the corresponding one of the channel lamp units CLa to CLn. For example, the “combination of simmer voltage and pulse” for each channel may be represented in the form of the right side (discharge operation) of the graph for the first channel 1ch, the graph for the second channel 2ch, and the graph for the N^{th} channel Nch in FIG. 4. For example, the “combination of simmer voltage and pulse” for all channels may be represented in the form shown in FIG. 3.

For example, the magnetic contactor MC may be a switch that transitions between the on state and the off state. For example, when the magnetic contactor MC is in one of the on state and the off state, it may apply the ignition voltage to the corresponding one of the channel lamp units CLa to CLn; when the magnetic contactor MC is in the other of the on state and off state, it may apply a combination of simmer voltage and pulse to the corresponding one of the channel lamp units CLa to CLn.

The charge bank CB may be charged with power supplied from the power supply PO and discharged to the pulse switch PS. In this specification, the charge bank CB may also be referred to as a “capacitor bank”.

The controller 30 controls the plurality of channel discharge parts 20a to 20n so that the channel discharge parts 20a to 20n discharge in sequence to the corresponding channel lamp unit CLa to CLn among the plurality of channel lamp units CLa to CLn.

For example, with reference to FIG. 1 and FIG. 3, assuming that there are N channel discharge parts 20a to 20n and N channel lamps CLa to CLn, and the cycle time for the discharge of all the first to N^{th} channel discharge parts 20a to 20n is T [sec], the controller 30 may control the plurality of channel discharge parts 20a to 20n so that the channel discharge parts 20a to 20n discharge in sequence at a frequency of N/T [Hz].

For example, the controller 30 may control the magnetic contactor MC so that the electronic contactor MC applies the ignition voltage to the corresponding one of the channel lamp units CLa to CLn. When the channel lamp units CLa to CLn emit light in response to application of the ignition voltage, the controller 30 may control the magnetic contactor MC to apply a combination of simmer voltage and pulse to the corresponding one of the channel lamp units CLa to CLn. Depending on the application of this combination of simmer voltage and pulse, the light source 10 may operate in such a way that the plurality of channel lamp units CLa to CLn irradiate flash light in sequence.

For example, with reference to FIGS. 1 and 3, assuming that the plurality of channel discharge parts 20a to 20n comprises first to N^{th} channel discharge parts 20a to 20n, and the cycle time for the discharge of all the first to N^{th} channel discharge parts 20a to 20n is T [sec], the controller 30 may control the plurality of channel discharge parts 20a to 20n so that the time interval between the pulse discharge of the i^{th} channel discharge part (i is a natural number ranging from 1 to N−1) and the pulse discharge of the i+1^{th} channel discharge part is to be T/N [sec].

For example, the controller 30 may control one or more of the power supply PO, the charge bank CB, and the pulse switch PS so that the time interval between the pulse discharge of the i^{th} channel discharge part and the pulse discharge of the i+1^{th} channel discharge part is T/N [sec].

According to a first feature of an embodiment of the disclosure, the multi-channel power control apparatus 100 may include: a light source 10 having a plurality of channel lamp units CLa to CLn; a plurality of channel discharge parts 20a to 20n performing discharging to each of the plurality of channel lamp units CLa~CLn, wherein each of the plurality of channel discharge parts 20a to 20n has a power supply PO and wherein each of the plurality of channel discharge parts 20a to 20n corresponds to each of the plurality of channel lamp units CLa to CLn; and a controller 30 configured to control the plurality of channel discharge parts 20a to 20n so that the plurality of channel discharge parts 20a to 20n discharges in sequence to a corresponding channel lamp unit CLa to CLn among the plurality of channel lamp units CLa to CLn.

Consequently, the output is gradual and stable, and efficient power management is possible by dispersing energy, and overheating may be prevented by heat dissipation. Additionally, each channel discharges independently to improve durability, and the output is stable without discharge interference, and the lifespan is long. In addition, it may be applied to a battery electrode drying system 1000 by maintaining an accurate discharge interval, and in the event of a failure, only the relevant module may be quickly replaced, thereby improving equipment productivity and reducing maintenance costs.

With reference to FIG. 5, a multi-channel power control apparatus 100A according to a first variation of an embodiment of the disclosure is described as follows.

The multi-channel power control apparatus 100A according to the first variation is configured such that one power supply PO′ supplies power to plural channel discharge parts 20a′ to 20n′, which is different from the configuration of the multi-channel power control apparatus 100 shown in FIG. 1.

Specifically, the multi-channel power control apparatus 100A according to the first variation includes a light source 10, a plurality of channel discharge parts 20a′ to 20n′, a power supply PO′, and a controller 30.

The light source 10 includes a plurality of channel lamp units CLa to CLn. The light source 10 may be a broadband light source that irradiates light having multiple wavelengths of a broadband wavelength band.

The plurality of channel discharge parts 20a′ to 20n′ perform discharging to each of the plurality of channel lamp units CLa to CLn. Each of the plurality of channel discharge parts 20a′ to 20n′ corresponds to each of the plurality of channel lamp units CLa to CLn.

The plurality of channel discharge parts 20a′ to 20n′ may each include an igniter IG, a simmer SI, and a pulse switch PS. The plurality of channel discharge parts 20a′ to 20n′ may each further include a magnetic contactor MC. The plurality of channel discharge parts 20a′ to 20n′ may each further include a charge bank CB.

The igniter IG may apply an ignition voltage to the corresponding one of the channel lamp units CLa to CLn.

The simmer SI may output a simmer voltage.

The pulse switch PS may discharge a pulse having a peak voltage higher than the simmer voltage.

The magnetic contactor MC may selectively apply one of ignition voltage and a combination of simmer voltage and pulse to the corresponding one of the channel lamp units CLa to CLn.

The charge bank CB may be charged with power supplied from the power supply PO′ and discharged to the pulse switch PS.

The power supply PO′ supplies power to the plurality of channel discharge parts 20a′ to 20n′.

The controller 30 controls the plurality of channel discharge parts 20a′ to 20n′ so that the channel discharge parts 20a′ to 20n′ discharge in sequence to the corresponding channel lamp unit CLa to CLn among the plurality of channel lamp units CLa to CLn.

For example, assuming that the plurality of channel discharge parts 20a′ to 20n′ comprises first to N^{th} channel discharge parts 20a′ to 20n′, and the cycle time for the discharge of all the first to N^{th} channel discharge parts 20a′ to 20n′ is T [sec], the controller 30 may control at least one of the plurality of channel discharge parts 20a′ to 20n′ or the power supply PO′ so that the time interval between the pulse discharge of the i^{th} channel discharge part (i is a natural number ranging from 1 to N−1) and the pulse discharge of the i+1^{th} channel discharge part is to be T/N [sec].

For example, the controller 30 may control one or more of the power supply PO′, the charge bank CB, and the pulse switch PS so that the time interval between the pulse discharge of the i^{th} channel discharge part and the pulse discharge of the i+1^{th} channel discharge part is T/N [sec].

According to a second feature of an embodiment of the disclosure, the multi-channel power control apparatus 100A may include: a light source 10 having a plurality of channel lamp units CLa to CLn; a plurality of channel discharge parts 20a′ to 20n′ performing discharging respectively to the plurality of channel lamp units CLa~CLn, wherein the plurality of channel discharge parts 20a′ to 20n′ correspond respectively to the plurality of channel lamp units CLa to CLn; a power supply PO′ configured to supply power to the plurality of channel discharge parts 20a′ to 20n; and a controller 30 configured to control the plurality of channel discharge parts 20a′ to 20n′ so that the plurality of channel discharge parts 20a′ to 20n′ discharge in sequence to the corresponding channel lamp units CLa to CLn.

With reference to FIG. 6, a multi-channel power control apparatus 100B according to a second variation of an embodiment of the disclosure is described as follows.

The multi-channel power control apparatus 100B according to the second variation is configured such that one charge bank CB discharges to a plurality of channel discharge parts 20a′ to 20n′, which is different from the configuration of the multi-channel power control apparatus 100A according to the first variation.

Specifically, the multi-channel power control apparatus 100B according to the second variation includes a light source 10, a plurality of channel discharge parts 20a′ to 20n′, a charge bank CB, a power supply PO′, and a controller 30.

The light source 10 includes a plurality of channel lamp units CLa to CLn. The light source 10 may be a broadband light source that irradiates light having multiple wavelengths of a broadband wavelength band.

The plurality of channel discharge parts 20a′ to 20n′ perform discharging respectively to the plurality of channel lamp units CLa to CLn. The plurality of channel discharge parts 20a′ to 20n′ correspond respectively to the plurality of channel lamp units CLa to CLn.

The plurality of channel discharge parts 20a′ to 20n′ may each include an igniter IG, a simmer SI, and a pulse switch PS. The plurality of channel discharge parts 20a′ to 20n′ may each further include a magnetic contactor MC.

The igniter IG may apply an ignition voltage to the corresponding one of the channel lamp units CLa to CLn.

The simmer SI may output a simmer voltage.

The pulse switch PS may discharge a pulse having a peak voltage higher than the simmer voltage owing to the discharge from the charge bank CB.

The magnetic contactor MC may selectively apply one of ignition voltage and a combination of simmer voltage and pulse to the corresponding one of the channel lamp units CLa to CLn.

The charge bank CB may be charged with power supplied from the power supply PO′ and discharged to the plurality of channel discharge parts 20a′ to 20n′. The charge bank CB may discharge to the pulse switch PS of each of the plurality of channel discharge parts 20a′ to 20n′.

The power supply PO′ supplies power to the charge bank CB so that the charge bank CB is charged.

The controller 30 controls the charge bank CB so that the plurality of channel discharge parts 20a′ to 20n′ discharge in sequence to the corresponding channel lamp unit CLa to CLn among the plurality of channel lamp units CLa to CLn.

For example, assuming that the plurality of channel discharge parts 20a′ to 20n′ are composed of first to N^{th} channel discharge parts 20a′ to 20n′, and the cycle time for the discharge of all the first to N^{th} channel discharge parts 20a′ to 20n′ is T [sec], the controller 30 may control at least one of the charge bank CB or the power supply PO′ so that the time interval between the pulse discharge of the i^{th} channel discharge part (i is a natural number ranging from 1 to N−1) and the pulse discharge of the i+1^{th} channel discharge part is to be T/N [sec].

According to a third feature of an embodiment of the disclosure, the multi-channel power control apparatus 100B may include: a light source 10 having a plurality of channel lamp units CLa to CLn; a plurality of channel discharge parts 20a′ to 20n′ performing discharging to each of the plurality of channel lamp units CLa~CLn, wherein each of the plurality of channel discharge parts 20a′ to 20n′ corresponds to each of the plurality of channel lamp units CLa to CLn; a charge bank CB configured to discharge to the plurality of channel discharge parts 20a′ to 20n′; a power supply PO′ configured to supply power to the charge bank CB so that the charge bank CB is charged; and a controller 30 configured to control the charge bank CB so that the plurality of channel discharge parts 20a′ to 20n′ discharges in sequence to a corresponding channel lamp unit CLa to CLn among the plurality of channel lamp units CLa to CLn.

With reference to FIG. 7, a battery electrode drying system 1000 equipped with a multi-channel power control apparatus 100 or 100A according to an embodiment of the disclosure is described as follows.

The battery electrode drying system 1000 includes a multi-channel power control apparatus 100 or 100A and a drying part 200.

The multi-channel power control apparatus 100 or 100A may be one or more of the multi-channel power control apparatus 100 according to an embodiment and the multi-channel power control apparatus 100A according to a modified embodiment, which have been described above.

The drying part 200 dries the battery electrode ES by utilizing flash light irradiated from the light source 10 of the multi-channel power control apparatus 100 or 100A. In this specification, “the drying part 200 dries the battery electrode ES” may mean “the drying part 200 dries electrode slurry (not shown) coated on at least one of the first surface S1 or the second surface S2 of the battery electrode ES”.

Additionally, the drying part 200 may coat electrode slurry on at least one of the first surface S1 or the second surface S2 of the battery electrode ES before drying the battery electrode ES.

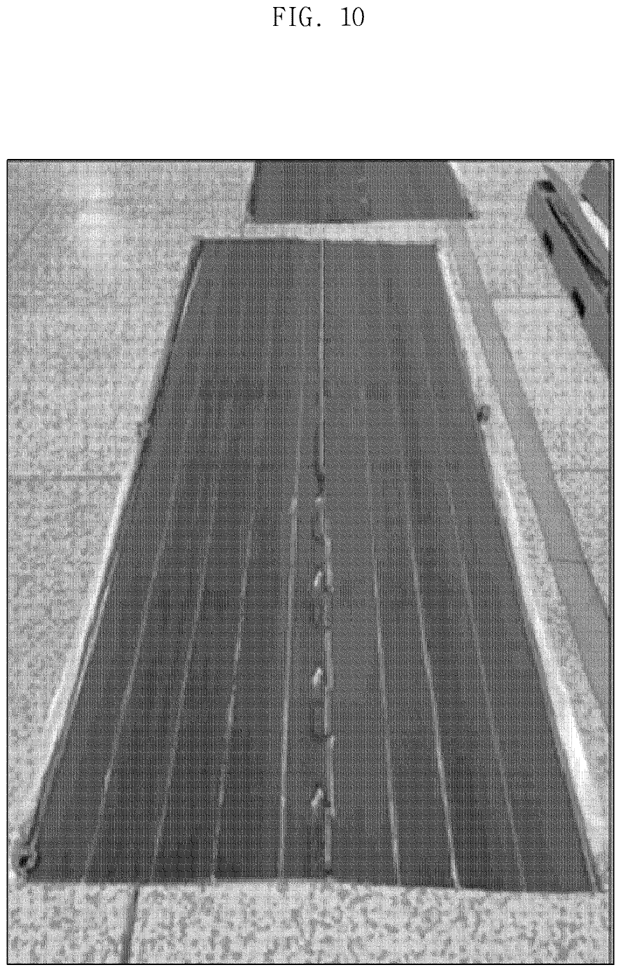

With reference to FIG. 8, it may be seen that the drying state of the electrode slurry coated on the surface of a battery electrode dried by a battery electrode drying system 1000 equipped with a multi-channel power control apparatus 100, 100A or 100B according to an embodiment of the disclosure is good compared to the drying state of the electrode slurry of a battery electrode dried by a related-art battery electrode drying system shown in FIG. 10.

According to a fourth feature of an embodiment of the disclosure, the battery electrode drying system 1000 may include: a multi-channel power control apparatus 100; and a drying part 200 that dries a battery electrode (ES) by utilizing flash light irradiated from the light source 10 of the multi-channel power control apparatus 100, wherein the multi-channel power control apparatus 100 may include: the light source 10 having a plurality of channel lamp units CLa to CLn; a plurality of channel discharge parts 20a to 20n performing discharging to each of the plurality of channel lamp units CLa~CLn, wherein each of the plurality of channel discharge parts 20a to 20n has a power supply PO and wherein each of the plurality of channel discharge parts 20a to 20n corresponds to each of the plurality of channel lamp units CLa to CLn; and a controller 30 configured to control the plurality of channel discharge parts 20a to 20n so that the plurality of channel discharge parts 20a to 20n discharge in sequence to a corresponding channel lamp unit CLa to CLn among the plurality of channel lamp units CLa to CLn.

According to a fifth feature of an embodiment of the disclosure, the battery electrode drying system 1000 may include: a multi-channel power control apparatus 100A; and a drying part 200 that dries a battery electrode (ES) by utilizing flash light irradiated from the light source 10 of the multi-channel power control apparatus 100, wherein the multi-channel power control apparatus 100A may include: the light source 10 having a plurality of channel lamp units CLa to CLn; a plurality of channel discharge parts 20a′ to 20n′ performing discharging to each of the plurality of channel lamp units CLa~CLn, wherein each of the plurality of channel discharge parts 20a′ to 20n′ corresponds to each of the plurality of channel lamp units CLa to CLn; a power supply PO′ configured to supply power to the plurality of channel discharge parts 20a′ to 20n; and a controller 30 configured to control the plurality of channel discharge parts 20a′ to 20n′ so that the plurality of channel discharge parts 20a′ to 20n′ discharges in sequence to a corresponding channel lamp unit CLa to CLn among the plurality of channel lamp units CLa to CLn.

According to a sixth feature of an embodiment of the disclosure, the battery electrode drying system 1000 may include: a multi-channel power control apparatus 100B; and a drying part 200 that dries a battery electrode (ES) by utilizing flash light irradiated from the light source 10 of the multi-channel power control apparatus 100B, wherein the multi-channel power control apparatus 100B may include: the light source 10 having a plurality of channel lamp units CLa to CLn; a plurality of channel discharge parts 20a′ to 20n′ performing discharging to each of the plurality of channel lamp units CLa~CLn, wherein each of the plurality of channel discharge parts 20a′ to 20n′ corresponds to each of the plurality of channel lamp units CLa to CLn; a charge bank CB configured to discharge to the plurality of channel discharge parts 20a′ to 20n′; a power supply PO′ configured to supply power to the charge bank CB so that the charge bank CB is charged; and a controller 30 configured to control the charge bank CB so that the plurality of channel discharge parts 20a′ to 20n′ discharge in sequence to a corresponding channel lamp unit CLa to CLn among the plurality of channel lamp units CLa to CLn.

Although the disclosure has been illustrated and described with reference to preferred embodiments of the attached exemplary drawings, it is not limited thereto, and it will be evident that those skilled in the art may carry out the disclosure in various forms within the scope of the technical concept of the disclosure described in the following claims.

What is claimed is

1. A multi-channel power control apparatus comprising:
a light source having a plurality of channel lamp units;
a plurality of channel discharge parts performing discharging to each of the plurality of channel lamp units, wherein each of the plurality of channel discharge parts has a power supply and wherein each of the plurality of channel discharge parts corresponds to each of the plurality of channel lamp units; and
a controller configured to control the plurality of channel discharge parts in a manner that the plurality of channel discharge parts discharges in sequence to a corresponding channel lamp unit among the plurality of channel lamp units,
wherein assuming that the plurality of channel discharge parts comprises first to N^{th} channel discharge parts and a cycle time for the discharge of all the first to N^{th} channel discharge parts is T seconds, the controller is configured to control the plurality of channel discharge parts in a manner that a time interval between pulse discharge of i^{th} channel discharge part (i is a natural number ranging from 1 to N−1) and pulse discharge of i+1^{th} channel discharge part is to be T/N seconds.

2. The multi-channel power control apparatus of claim 1, wherein each of the plurality of channel discharge parts further includes:
an igniter to apply an ignition voltage to the corresponding channel lamp unit;
a simmer to output a simmer voltage; and
a pulse switch to discharge a pulse having a peak voltage higher than the simmer voltage.

3. The multi-channel power control apparatus of claim 2, wherein each of the plurality of channel discharge parts further includes a magnetic contactor that selectively applies one of the ignition voltage and a combination of the simmer voltage and the pulse to the corresponding channel lamp unit.

4. The multi-channel power control apparatus of claim 2, wherein each of the plurality of channel discharge parts further includes a charge bank that is charged with power supplied from the power supply and discharged to the pulse switch.

5. The multi-channel power control apparatus of claim 1, wherein the light source is a broadband light source that irradiates light having multiple wavelengths of a broadband wavelength band.

6. A multi-channel power control apparatus comprising:
a light source having a plurality of channel lamp units;
a plurality of channel discharge parts performing discharging to each of the plurality of channel lamp units, wherein each of the plurality of channel discharge parts corresponds to each of the plurality of channel lamp units;
a power supply to supply power to the plurality of channel discharge parts; and
a controller configured to control the plurality of channel discharge parts in a manner that the plurality of channel discharge parts discharges in sequence to a corresponding channel lamp unit among the plurality of channel lamp units,
wherein assuming that the plurality of channel discharge parts comprises first to N^{th} channel discharge parts and a cycle time for the discharge of all the first to N^{th} channel discharge parts is T seconds, the controller is configured to control at least one of the plurality of channel discharge parts or the power supply in a manner that a time interval between pulse discharge of i^{th} channel discharge part (i is a natural number ranging from 1 to N−1) and pulse discharge of i+1^{th} channel discharge part is to be T/N seconds.

7. The multi-channel power control apparatus of claim 6, wherein each of the plurality of channel discharge parts further includes:
an igniter to apply an ignition voltage to the corresponding channel lamp unit;
a simmer to output a simmer voltage; and
a pulse switch to discharge a pulse having a peak voltage higher than the simmer voltage.

8. The multi-channel power control apparatus of claim 7, wherein each of the plurality of channel discharge parts further includes a magnetic contactor that selectively applies one of the ignition voltage and a combination of the simmer voltage and the pulse to the corresponding channel lamp unit.

9. The multi-channel power control apparatus of claim 7, wherein each of the plurality of channel discharge parts further includes a charge bank that is charged with power supplied from the power supply and discharged to the pulse switch.

10. The multi-channel power control apparatus of claim 6, wherein the light source is a broadband light source that irradiates light having multiple wavelengths of a broadband wavelength band.

11. A multi-channel power control apparatus comprising:
a light source having a plurality of channel lamp units;
a plurality of channel discharge parts performing discharging to each of the plurality of channel lamp units, wherein each of the plurality of channel discharge parts corresponds to each of the plurality of channel lamp units;
a charge bank to perform discharging to the plurality of channel discharge parts;
a power supply to supply power to the charge bank so as to charge the charge bank; and
a controller configured to control the charge bank in a manner that the plurality of channel discharge parts discharges in sequence to a corresponding channel lamp unit among the plurality of channel lamp units,
wherein assuming that the plurality of channel discharge parts comprises first to N^{th} channel discharge parts and a cycle time for the discharge of all the first to N^{th} channel discharge parts is T seconds, the controller is configured to control at least one of the charge bank or the power supply in a manner that a time interval between pulse discharge of i^{th} channel discharge part (i is a natural number ranging from 1 to N−1) and pulse discharge of i+1^{th} channel discharge part is to be T/N seconds.

12. The multi-channel power control apparatus of claim 11, wherein each of the plurality of channel discharge parts further includes:
an igniter to apply an ignition voltage to the corresponding channel lamp unit;
a simmer to output a simmer voltage; and
a pulse switch to discharge a pulse having a peak voltage higher than the simmer voltage owing to discharging from the charge bank.

13. The multi-channel power control apparatus of claim 12, wherein each of the plurality of channel discharge parts further includes a magnetic contactor that selectively applies one of the ignition voltage and a combination of the simmer voltage and the pulse to the corresponding channel lamp unit.

14. The multi-channel power control apparatus of claim 11, wherein the light source is a broadband light source that irradiates light having multiple wavelengths of a broadband wavelength band.

15. A battery electrode drying system comprising:
a multi-channel power control apparatus according to claim 1; and
a drying part that dries a battery electrode by utilizing flash light irradiated from the light source of the multi-channel power control apparatus.

16. The battery electrode drying system of claim 15, wherein the drying part coats electrode slurry on at least one of a first surface or a second surface of the battery electrode before drying the battery electrode.

17. A battery electrode drying system comprising:
a multi-channel power control apparatus according to claim 6; and
a drying part that dries a battery electrode by utilizing flash light irradiated from the light source of the multi-channel power control apparatus.

18. The battery electrode drying system of claim 17, wherein the drying part coats electrode slurry on at least one of a first surface or a second surface of the battery electrode before drying the battery electrode.

19. A battery electrode drying system comprising:
a multi-channel power control apparatus according to claim 11; and
a drying part that dries a battery electrode by utilizing flash light irradiated from the light source of the multi-channel power control apparatus.

20. The battery electrode drying system of claim 19, wherein the drying part coats electrode slurry on at least one of a first surface or a second surface of the battery electrode before drying the battery electrode.
